(19) United States
(12) Patent Application Publication
(10) Pub. No.: US 2025/0010159 A1
(43) Pub. Date: Jan. 9, 2025

(54) SYSTEM AND METHOD TO ACCELERATE THE PROCESS OF DEVELOPING AND LEARNING NEW COGNITIVE SKILLS

(71) Applicants: Jared Lee Lewandowski, Saratoga Springs, UT (US); Matthew Chase, Saratoga, CA (US)

(72) Inventors: Jared Lee Lewandowski, Saratoga Springs, UT (US); Matthew Chase, Saratoga, CA (US)

(21) Appl. No.: 18/738,809

(22) Filed: Jun. 10, 2024

Related U.S. Application Data
(60) Provisional application No. 63/512,122, filed on Jul. 6, 2023.

(51) Int. Cl. A63B 69/36

(52) U.S. Cl. CPC A63B 69/36; A63B 2220/833; A63B 2220/836; A63B 2225/20

(57) ABSTRACT

A data processing system and method for collecting data and providing feedback to a user on the proper movement associated with a task. The data processing system can include a sensor device worn by a user while performing the task. The sensor device includes a number of sensors and feedback devices for collecting user movement data while performing the task, analyzing the data and providing feedback based on the collected data. The data processing system can include a mobile device and application that receives collected data from the sensor device and can provide further analysis and insight to the user based on the collected data. Data processing method includes algorithms for processing collected data and providing feedback on the collected data.

### CROSS-REFERENCE TO RELATED APPLICATION

This application claims the benefit of priority of U.S. provisional application No. 63/512,122, filed Jul. 6, 2023, the contents of which are herein incorporated by reference.

### BACKGROUND OF THE INVENTION

The present invention relates to training systems, and methods and, more particularly, to a data processing system and method configured to track the movement of a hand(s) and provide feedback for developing and learning cognitive skill(s).

Hand position and movement play an important role when learning any new skill in any sport, including golf, which requires the use of hands. In golf for example, training aids are often big and bulky, not personalized to the athlete's size, stature, and individual characteristics, and are typically not allowed for use while competitively participating in the sport. Today, there are no devices which can accurately track specific hand position and movement discreetly while attached to the human hand, or any part of the hand that uses real-time electrical feedback mechanisms to produce immediate improvements while using the device.

Other devices are focused solely on communicating the problem, or the results of the problem, to the athlete using data, but do not offer an immediately applicable solution nor help fix the problem simultaneously. For example, launch monitors and shot trackers, such as Trackman, Arccos, Rapsodo, etc., provide detail information on ball flight and associated attributes but fail to provide feedback, or potential corrective actions. Other similar methods, like in-person coaching, simulators, and training facilities, can take months, even years, and a lot of money, to see even slight progress or improvement. Furthermore, these methods provide no ability for real-time feedback on-course, or during play, which requires a user to self-diagnose and self-correct potential problems.

Today, athletes wanting to improve upon a skill typically need years of personal assistance, coaching, or require a large and bulky object that physically obstructs their natural ability to use the device during actual play or without being seen by others.

As can be seen, there is a need for a data processing system and method that includes an unintrusive apparatus for tracking hand position and providing real-time feedback to correct flaws.

### SUMMARY OF THE INVENTION

In one aspect of the present invention, a system for learning a task is disclosed. The system can include a wearable device which includes a plurality of sensors, feedback device, at least one processor, and at least one memory storing instructions that when executed cause the at least one processor to perform a method. The method performed by the system can include collecting, by the plurality of sensors of the wearable device, at least one data associated with performance of the task being learned. The collected data can then be analyzed by the wearable device utilizing one or more algorithms to determine at least one insight. In embodiments, the algorithms can include machine learning and/or artificial intelligence algorithms for determining insights from the data collected. Based on the at least one insight determined by the algorithms the wearable device can provide at least one feedback.

In another aspect of the present invention, a computer-implemented method for learning a task is disclosed. The method performed by the system can include collecting, by the plurality of sensors of the wearable device, at least one data associated with performance of the task being learned. The collected data can then be analyzed by the wearable device utilizing one or more algorithms to determine at least one insight. In embodiments, the algorithms can include machine learning and/or artificial intelligence algorithms for determining insights from the data collected. Based on the at least one insight determined by the algorithms the wearable device can provide at least one feedback.

These and other features, aspects and advantages of the present invention will become better understood with reference to the following drawings, description, and claims.

### BRIEF DESCRIPTION OF THE DRAWINGS

The features and advantages of the present invention will become more apparent from the detailed description set forth below when taken in conjunction with the following drawings.

FIG. 1 illustrates a perspective view of the system shown in-use, according to an example embodiment;

FIG. 2 illustrates an exploded sectional view of FIG. 1, according to an example embodiment;

FIG. 3 illustrates a perspective view of the system, according to an example embodiment;

FIG. 4 illustrates an enlarged detail view of the system, according to an example embodiment;

FIG. 5 illustrates a section view taken along line 4 from FIG. 4, system shown in full, according to an example embodiment;

FIG. 6 illustrates a topside view of a golfing glove with system attached, according to an example embodiment;

FIG. 7 illustrates a bottom side view of the glove; according to an example embodiment; and

FIG. 8 illustrates a process flowchart of an algorithm, according to an example embodiment; and

FIG. 9 illustrates a block diagram of a general and/or special purpose computer, which may be a general and/or special purpose computing device, according to an example embodiment.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

As stated above, hand position and movement play an important role when learning any new skill in any sport which requires the use of hands. Today, there are no devices which can accurately track specific hand position and movement discreetly while attached to a user, or any devices that use real-time electrical feedback mechanisms to produce immediate improvements while using the device.

In golf for example, training aids are often big and bulky, not personalized to the user's size, stature, and/or individual characteristics, and are usually not able to be used while actually playing the sport. Other devices in the field of this invention, such as Trackman and Arrcos, are focused solely on communicating the problem, or the results of the problem, to the athlete, but do not offer an immediately applicable solution nor help fix the problem instantly. Other similar methods, like in-person coaching, simulators, and training facilities, can take months, even years, and significant monetary investment, in order to see even slight progress or improvement.

Existing devices and methods have a high rate of failure for breaking ingrained habits, and/or learning new habits, due to a lack of regular and consistent feedback, or coaching, during performance or playing their respective sport in real and regular scenarios. Without this feedback, or coaching, a user will often quickly revert to their original habits, greatly limiting their ability to improve.

This invention utilizes SMART (self-monitoring, analysis, and reporting technology), machine learning (ML), and artificial intelligence (AI) to detect, record, and learn from specific movements utilizing a sensor embedded in playing apparel, or otherwise attached to a user, which provides immediate, real-time, feedback to the user through lighting, or haptic feedback, to reinforce proper form, and/or hand usage. By increasing awareness and providing regular feedback to the user, using existing sporting equipment such as gloves, this invention serves as a natural feeling and reliable training aid for knowing when and how to position a user's hands while actively playing their sport. The invention also uses this information to communicate back to the athlete areas of further improvement.

The present invention differs from what currently exists by allowing a user to use the invention during practice, tournaments, or official play, to capture critical hand position and movement data, while also getting immediate results and improvement without any physical interference. The invention collects, analyzes, and communicates critical hand and swing information such as position and movement, including grip position, swing speed, swing plane, acceleration, and more, to share with others and improve their game. The invention can even compare a user's pattern to those of a professional to help the user compare and improve.

Through discreet and convenient repetition, this invention gives a user a subtle cue to focus on before they act, while at the same time recording the hand position and movement for later review. This invention creates a sense of natural confidence through on-course usage while helping a user to learn quickly without being physically forced to do something to get results.

Broadly, one embodiment of the present invention is a system and data processing method for analyzing hand movements of a user performing a task. The system and method collect data, utilizing an unintrusive sensor device affixed to sporting apparel, which is analyzed utilizing utilizes SMART (self-monitoring, analysis, and reporting technology), machine learning (ML), and artificial intelligence (AI) algorithms to provide immediate, real-time, feedback to the user through lighting, or haptic feedback, to reinforce proper form, and/or hand usage.

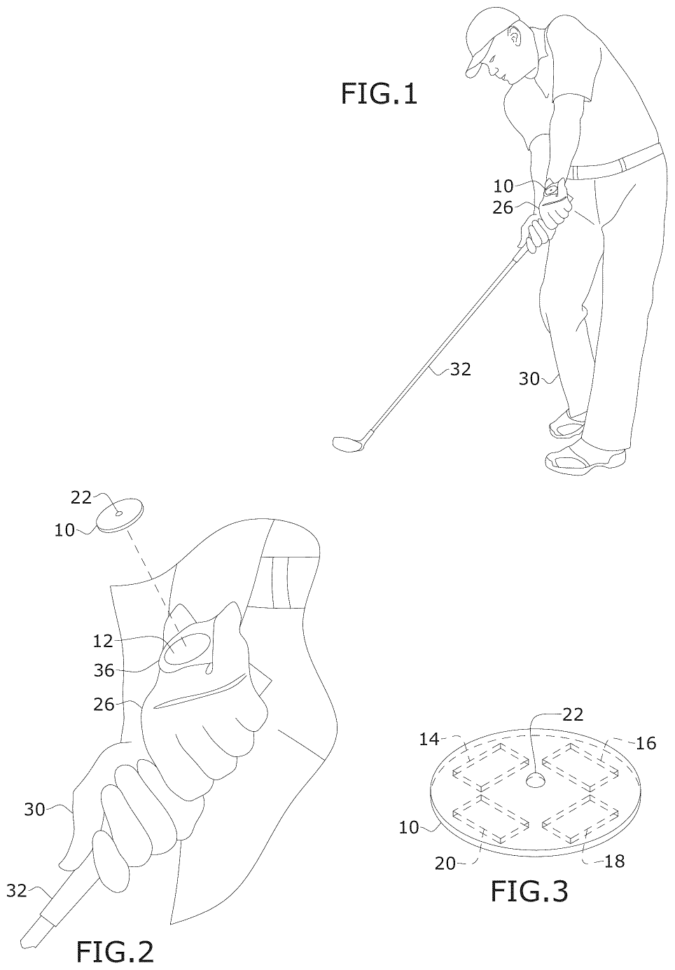

Referring now to FIGS. 1-7, aspects of an embodiment of a training system for developing new skills are illustrated. FIG. 1 illustrates a user 30 can be playing a sport, such as golf, and wishes to have analysis and feedback on the proper manipulation of a club 32, to improve their game performance. The user can affix, or otherwise installed, a sensor device 10 to sporting apparel, such as a glove 26, such that sensor device 10 can track, analyze, and provide feedback on the movements of one or more of user's 30 hands. In alternative embodiments, the device may be affixed directly to the user. In embodiments, once affixed, or otherwise installed, sensor device 10 can collect a variety of data regarding the movement of one or more of user's 30 hands during the manipulation of club 32. In embodiments, the variety of collected data can be processed by one or more algorithms, such as machine learning, artificial intelligence, etc., to provide feedback or analysis to the user. Furthermore, in response to the variety of collected data, sensor device 10 can provide feedback to user 30 regarding proper manipulation of club 32 in real-time during usage. In embodiments, feedback can be provided visually, haptically, or otherwise, and can include feedback based on one or more algorithmic analysis, suggestions, or recommendations. While an exemplary use-case of the system is illustrated with respect to the sport of golf, it is understood that the system can be utilized to track, analyze, and provide feedback to a user in any scenario sporting, or otherwise, where proper hand manipulation is required.

As shown in FIG. 2, sensor device 10 can be removably affixed, or otherwise installed, on a coupling tab 36 of glove 26 worn by user 30. In embodiments, sensor device can be affixed to coupling tab 36 by attachment means 12 recessed in a portion of coupling tab 36. In embodiments, attachment means can be a magnet, button, clip, clasp, or other known structure. In alternative embodiments, an attachment means can be provided on sensor device 10, which can allow sensor device to attach to any apparel, or without the need for apparel. In embodiments, sensor device 10 can be sized to fit within a recess of coupling tab 36, as illustrated in FIG. 5. A light 22 can be provided on sensor device 10 to provide feedback to user 30 on the proper hand position/usage/movement, or to otherwise indicate functionality associated with sensor device 10. In embodiments, light 22 can be a light emitting diode configured to display a variety of colors.

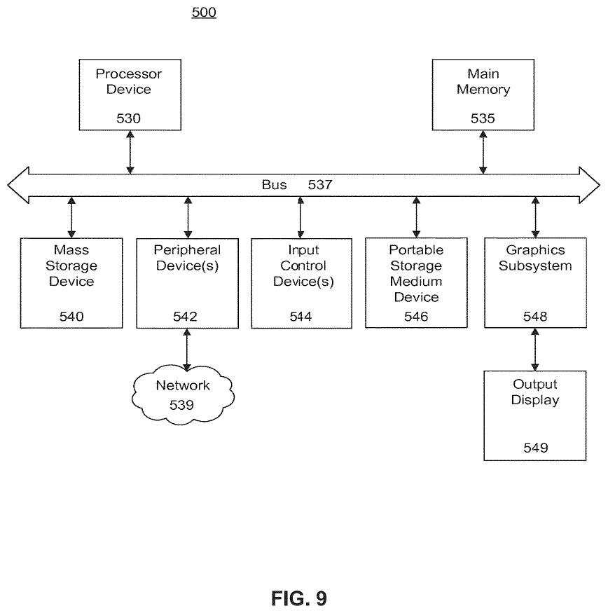

Referring now to FIG. 3, components of sensor device 10 are illustrated. Sensor device 10 includes a plurality of electrical and/or electromechanical devices to track, record, and/or provide feedback on the movement and/or position of at least one of user's 30 hands. In embodiments, the number of electrical and/or electromechanical devices can include a gyroscope 14, an accelerometer 16, light 22, a reed switch (not shown) and/or a haptic actuator, such as an eccentric rotating mass (ERM) actuator, Piezoelectric Actuator, or Linear Resonant Actuator (not shown). Sensor device 10 can include a number of additional processing devices such as an internal microprocessor (not shown) configured to perform overall management of sensor device 10, an internal memory chip (not shown), such as a solid-state memory chip, configured to store data collected, or otherwise captured, processing instructions, and one or more algorithms, a Bluetooth® chip 18 configured to transmit data collected to an external device for further processing, and a battery 20 configured to power all components of sensor device 10. In embodiments, battery 20 can be lithium ion, or Lithium-Polymer, and can be rechargeable. In embodiments the internal microprocessor can be a general and/or special purpose computer 500, as illustrated in FIG. 9, and Bluetooth® chip 18 can be either Bluetooth® protocol, or Bluetooth® Low Energy protocol. In embodiments, components of sensor device 10 can be installed on a printed circuit board (PCB).

Additional elements contemplated to be included in the plurality of electrical and/or electromechanical devices include, but are not limited to, a compass, and/or a compass sensor for determining a heading or distance travelled of sensor device 10, one or more power switches, such as a recessed power switch, and/or a light pipe. Additionally, all elements, or a subset thereof, of sensor device 10 can be affixed, or otherwise installed on a custom designed printed circuit board.

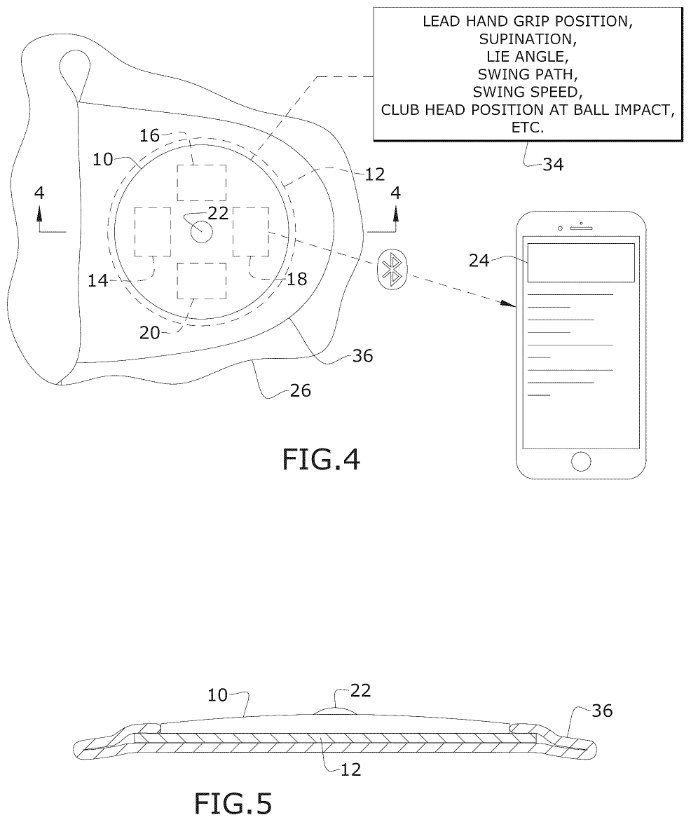

Referring now to FIG. 4, operation of components of the training system are illustrated. Sensor device 10, when seated within coupling tab can be activated by attachment means 12. In embodiments, attachment means 12 can be a magnet which can cause actuation of the reed switch, disposed between battery 20 and the number of electrical and/or electromechanical devices, in sensor device 10 thereby causing power-up of sensor device 10. In other embodiments, sensor device 10 can be powered-up by actuation of a power switch, such as a recessed power switch. Upon power up, light 22 can provide an indication of functionality to user 30. In embodiments, upon power up light 22, as an LED, can blink green 5 times to indicate sensor device 10 is on and functionally. Additionally, light 22, as an LED, can blink blue 1 time to indicate a successful Bluetooth® connection. In embodiments, light 22 can blink red, a number of times, to indicated faults in functionality, such as low battery power. For example, when sensor device 10 has less than 20% battery remaining, the LED light blinks RED up to four times. Once for every 5% less remaining from 20%. For example, once for 20%, two times for 15%, three times for 10% and four times for 5%.

As shown in FIG. 4, sensor device 10 can connect to a mobile device running a native mobile companion application 24. In embodiments, sensor device 10 can transmit information from the plurality of electrical and/or electromechanical devices to the native mobile application 24. In embodiments, the native mobile application can capture, store, and analyze in real-time a plurality of data 34 (but not limited to): hand movement, hand position, swing acceleration, swing speed, swing g-force, swing plane, etc. Mobile application 24 can also provide user 30 with the ability to manage the following (but limited to): battery levels of sensor device 10, provide other relevant statistics and data related to the sensor device's performance and quality, and ability to purchase related products and services. Advantageously, utilization of the mobile device with native mobile application 24 can allow for additional processing power, as well as storing user data for later review, analysis, and/or sharing with other users.

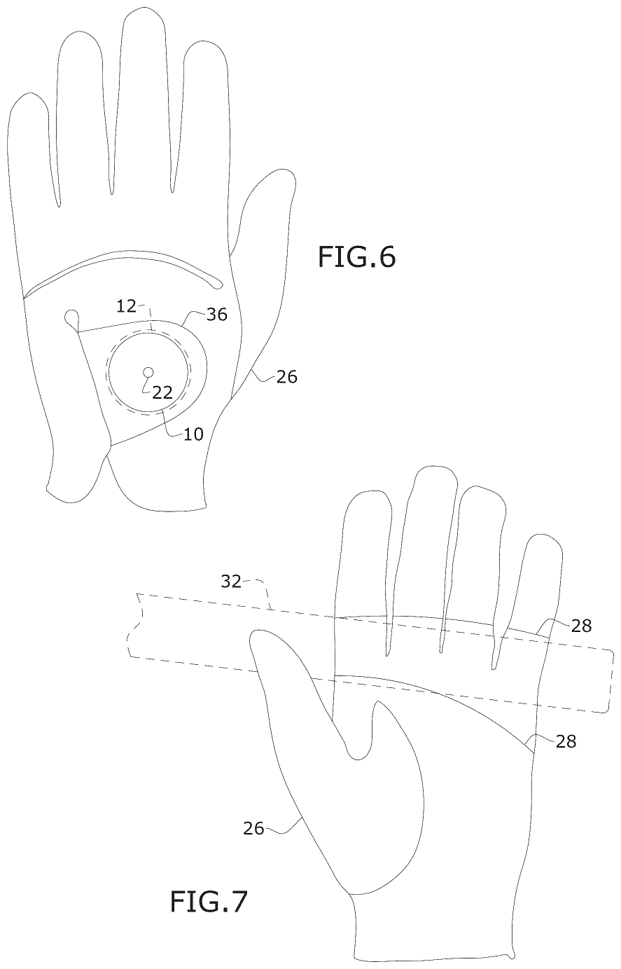

Referring now to FIGS. 6-7, aspects of grip detection and associated views of golf glove 26 are illustrated. A top view of glove 26 illustrates a view of user 30 when looking down on glove 26, installed on a hand of user 30. In embodiments, light 22 on sensor device 10 is visible to the user when gripping club 32. In embodiments, user 30 can grip a club 32 as guided by guidelines 28 disposed on glove 26. In embodiments, once a proper grip is detected by sensor device 10, light 22 can provide an indication of a proper grip, such as a green light, and data collection can begin. In embodiments, one or more pre-loaded algorithms, such as machine learning, artificial intelligence, or other computation algorithm, are fed data by sensor device 10, which is utilized by the one or more algorithms to determine whether a user grip is proper. Advantageously, the ability of the user to view light 22, while performing motions consistent with game play, allows for real-time unobtrusive feedback to the user.

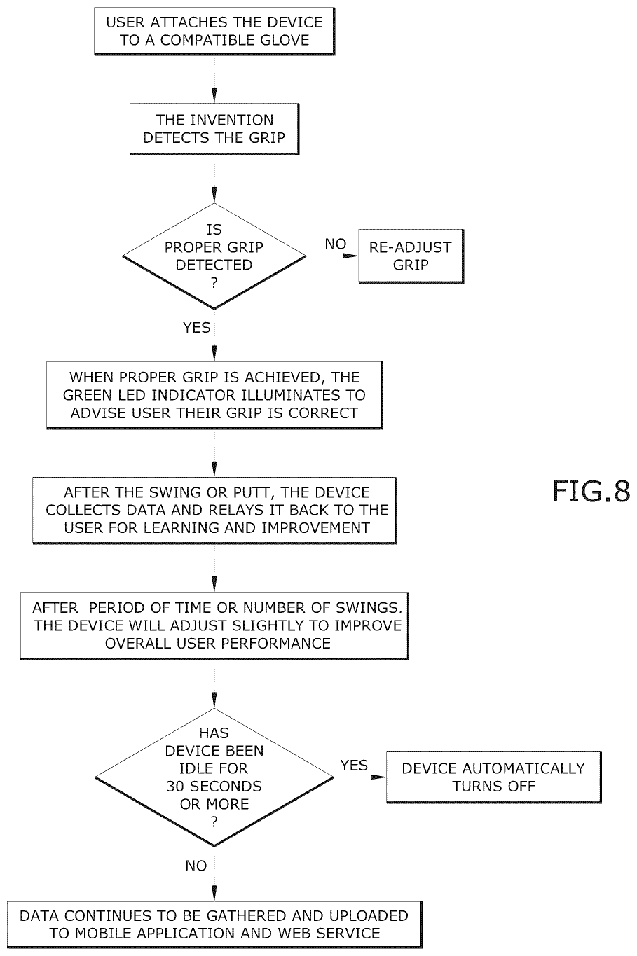

Referring now to FIG. 8, aspects of a method of using the system are illustrated. The method can begin with a user attaching sensor device 10 to their hand, or body part, that they wish to track. In embodiments, sensor device can be attached to sporting apparel consistent with the sport being played, such as a golf glove, batting glove, football glove, etc. In embodiments, attachment of sensor device 10 is accomplished through attachment means 12, as described above. Furthermore, sensor device can be powered on in response to attachment such as by communicative coupling between attachment means 12 and a reed switch of sensor device 10, as described above.

Once attachment of sensor device 10 has been effectuated, grip detection is performed by the system using sensor device 10. Utilizing measurements from sensor device 10, the system determines if a proper grip is detected. In the absence of a proper grip the user must re-adjust their grip position until a proper grip is detected. If a proper grip is detected, light 22 illuminates to indicate successful grip positioning. In embodiments, one or more algorithms are preloaded on sensor device 10, which can be fed data from sensor device to determine if a proper grip is detected. In embodiments, the one or more algorithms can be a machine learning, artificial intelligence, or other computational algorithm. In embodiments, light 22 is an LED that illuminates green when a proper grip position is detected. Additionally, once a proper grip is detected, sensor device 10 can be activated to begin tracking movement data, which includes forming a wireless connection to a mobile device of the system, as described above.

Once sensor device 10 is activated to collect movement data, the user can swing a club, or otherwise move the tracked body part, which is tracked by sensor device 10. In embodiments, the user can swing a club, such as a golf club, and sensor device 10 can collect data on each swing. In embodiments, data collected can include one or more of the following: hand movement, hand position, swing acceleration, swing speed, swing g-force, swing plane, etc. In embodiments, one or more pre-loaded algorithms, such as machine learning, artificial intelligence, or other computational algorithm, can be utilized to convert, or otherwise translate, sensor data from sensor device 10 into one or more of: hand movement, hand position, swing acceleration, swing speed, swing g-force, swing plane, etc. Furthermore, data from sensor device 10 can be transmitted to mobile application 24, as described above, for display, and further analysis. In embodiments, feedback can be provided by one or more electromechanical devices of sensor device 10, based on the data gathered. In embodiments, one or more pre-loaded algorithms, such as machine learning, artificial intelligence, or other computational algorithm can be utilized in mobile application 24 to provide analysis of data, and feedback, recommendations, or suggestions to a user. In embodiments, light 22 can provide visual feedback to user, such as green light indicating proper movement based on the collected data and/or red light indicating improper movement, while haptic actuator can provide haptic feedback, such as vibration, based on improper movement based on the collected data. Advantageously, collection of data and feedback provided by sensor device 10 in real-time, during performance of an activity, allows for rapid improvement of technique.

A further aspect of the method includes an adaptive training system, which can provide incremental adjustments to the user based on data collected after any number of swings. In embodiments, the system can utilize machine learning and artificial intelligence algorithms to analyze data collected by sensor device 10. These algorithms can provide incremental adjustments to the user to slowly change improper movement techniques. For example, sensor device 10 can provide grip data which the algorithms can use to classify a grip of the user as strong, or weak, and in either case can provide feedback to slowly move the grip of the user to a neutral position, a weaker position, or a stronger position, based on the needs indicated. In another example, sensor device can provide swing path data, which the algorithms can use to classify a path as inside, or outside, and in either case can provide feedback to slowly move the swing path more inside, or outside, as needed. Advantageously, incremental feedback allows the user of the system to correct their form without noticing substantial changes.

Sensor device 10 can continue to collect and transmit data to mobile application 24 unless a stop condition has been detected. In embodiments, the stop condition is an idle condition. For example, if sensor device remains idle for 30 seconds or more it will turn off, otherwise data collection and transmission will continue. Advantageously, a threshold in this manner allows for battery savings, as a user does not need to remember to power off the device when not in use.

A non-limiting, exemplary use-case is provided with respect to FIG. 8 and sensor device 10. A user can attach sensor device 10 to their hand or body using a glove 26 to know when their hands or body are in the correct or preferred position. When the user has positioned themselves into the correct position, light 22 illuminates green on sensor device 10. At the time light 22 illuminates, sensor device 10 can begin to record sensor data from the electrical and electromechanical devices such Accelerometer 16, Gyro sensor 14, and Compass (not shown) during a full swing of the club.

Data from the electrical and electromechanical devices can track swing path and other performance data, which can be Mobile application 24 via the Bluetooth module 18. Mobile Application 24 can then evaluate the swing data and other performance data and can filter out non-play data. After filtering the non-useful data, machine learning AI (artificial intelligence) can then makes suggestions for the player to improve their swing performance and provides notifications to the user on changes in their play real time.

Mobile Application can include GPS location functionality to compare the location of each ball strike to establish the distances between ball strikes, tracking the distance of hit. New skills and habits are quickly learned while delivering immediate results with no physical force or redirection. Machine learning (and AI) in Mobile Application 24 can make adjustments to the base algorithms when the green light illuminates. The purpose of these small changes over time are to move the player into a more neutral strong grip, rather than a very strong grip that it utilizes with new users. Mobile application 24 can be designed to take user feedback upon initial set-up, establishing a baseline for how the user is needing improvement in their play (Examples: Slice or Hook off the T with a driver). Sensor device 10 can include a different/adaptive algorithm depending on how the user struggles during play with their initial set-up of the device.

FIG. 9 is a block diagram of a general and/or special purpose computer 500, which may be a general and/or special purpose computing device, in accordance with some of the example embodiments of the invention. The computer 500 may be, for example, a user device, a user computer, a client computer and/or a server computer, among other things.

The computer 500 may include without limitation a processor device 530, a main memory 535, and an interconnect bus 537. The processor device 530 may include without limitation a single microprocessor or may include a plurality of microprocessors for configuring the computer 500 as a multi-processor system. The main memory 535 stores, among other things, instructions and/or data for execution by the processor device 530. The main memory 535 may include banks of dynamic random-access memory (DRAM), as well as cache memory.

The computer 500 may further include a mass storage device 540, peripheral device(s) 542, non-transitory storage medium device(s) 546, input control device(s) 544, a graphics subsystem 548, and/or a display 549. For explanatory purposes, all components in the computer 500 are shown in FIG. 9 as being coupled through the bus 537. However, the computer 500 is not so limited. Devices of the computer 500 may be coupled through one or more data transport means. For example, the processor device 530 and/or the main memory 535 may be coupled through a local microprocessor bus. The mass storage device 540, peripheral device(s) 542, portable storage medium device(s) 546, and/or graphics subsystem 548 may be coupled via one or more input/output (I/O) buses. The mass storage device 540 may be a nonvolatile storage device for storing data and/or instructions for use by the processor device 530. The mass storage device 540 may be implemented, for example, with a magnetic disk drive or an optical disk drive. In a software embodiment, the mass storage device 540 is configured for loading contents of the mass storage device 540 into the main memory 535.

The portable storage medium device 546 operates in conjunction with a nonvolatile portable storage medium, such as, for example, a compact disc read only memory (CD-ROM), to input and output data and code to and from the computer 500. In some embodiments, the software for storing information may be stored on a portable storage medium and may be inputted into the computer 500 via the portable storage medium device 546. The peripheral device(s) 542 may include any type of computer support device, such as, for example, an input/output (I/O) interface configured to add additional functionality to the computer 500. For example, the peripheral device(s) 542 may include a network interface card for interfacing the computer 500 with a network 439.

The input control device(s) 544 provides a portion of the user interface for a user of the computer 500. The input control device(s) 544 may include a keypad and/or a cursor control device. The keypad may be configured for inputting alphanumeric characters and/or other key information. The cursor control device may include, for example, a handheld controller or mouse, a trackball, a stylus, and/or cursor direction keys. In order to display textual and graphical information, the computer 500 may include the graphics subsystem 548 and the output display 549. The output display 549 may include a cathode ray tube (CRT) display and/or a liquid crystal display (LCD). The graphics subsystem 548 receives textual and graphical information and processes the information for output to the output display 549.

Each component of the computer 500 may represent a broad category of a computer component of a general and/or special purpose computer. Components of the computer 500 are not limited to the specific implementations provided here.

Software embodiments of the example embodiments presented herein may be provided as a computer program product, or software, that may include an article of manufacture on a machine-accessible or machine-readable medium having instructions. The instructions on the non-transitory machine-accessible machine-readable or computer-readable medium may be used to program a computer system or other electronic device. The machine- or computer-readable medium may include, but is not limited to, floppy diskettes, optical disks, CD-ROMs, and magneto-optical disks or other types of media/machine-readable medium suitable for storing or transmitting electronic instructions. The techniques described herein are not limited to any particular software configuration. They may find applicability in any computing or processing environment. The terms “computer-readable”, “machine-accessible medium” or “machine-readable medium” used herein shall include any medium that is capable of storing, encoding, or transmitting a sequence of instructions for execution by the machine and that causes the machine to perform any one of the methods described herein. Furthermore, it is common in the art to speak of software, in one form or another (e.g., program, procedure, process, application, module, unit, logic, and so on), as taking an action or causing a result. Such expressions are merely a shorthand way of stating that the execution of the software by a processing system causes the processor to perform an action to produce a result.

Portions of the example embodiments of the invention may be conveniently implemented by using a conventional general-purpose computer, a specialized digital computer and/or a microprocessor programmed according to the teachings of the present disclosure, as is apparent to those skilled in the computer art. Appropriate software coding may readily be prepared by skilled programmers based on the teachings of the present disclosure.

Some embodiments may also be implemented by the preparation of application-specific integrated circuits, field programmable gate arrays, or by interconnecting an appropriate network of conventional component circuits.

Some embodiments include a computer program product. The computer program product may be a storage medium or media having instructions stored thereon or therein which can be used to control, or cause, a computer to perform any of the procedures of the example embodiments of the invention. The storage medium may include without limitation a floppy disk, a mini disk, an optical disc, a Blu-ray Disc, a DVD, a CD or CD-ROM, a micro-drive, a magneto-optical disk, a ROM, a RAM, an EPROM, an EEPROM, a DRAM, a VRAM, a flash memory, a flash card, a magnetic card, an optical card, nanosystems, a molecular memory integrated circuit, a RAID, remote data storage/archive/warehousing, and/or any other type of device suitable for storing instructions and/or data.

Stored on any one of the computer readable medium or media, some implementations include software for controlling both the hardware of the general and/or special computer or microprocessor, and for enabling the computer or microprocessor to interact with a human user or other mechanism utilizing the results of the example embodiments of the invention. Such software may include without limitation device drivers, operating systems, and user applications. Ultimately, such computer readable media further include software for performing example aspects of the invention, as described above.

Included in the programming and/or software of the general and/or special purpose computer or microprocessor are software modules for implementing the procedures described above.

While various example embodiments of the present invention have been described above, they have been presented by way of example, and not limitation. It can be apparent to people skilled in the relevant art(s) that various changes in form and detail can be made therein. Thus, the present invention should not be limited by any of the above-described example embodiments but should be defined only in accordance with the following claims and their equivalents.

What is claimed is:

1. A system for learning a task, comprising:
a wearable device including:
at least one processor, and at least one memory storing instructions that when executed cause the at least one processor to perform a method, the method comprising:
collecting, by the wearable device, at least one data associated with performance of the task;
analyzing, by the wearable device, the at least one data to determine at least one first insight;
providing, by the wearable device, at least one first feedback based on the at least one first insight.

2. The system of claim 1, wherein the analyzing is performed by one or more machine learning algorithms pre-loaded on the wearable device.

3. The system of claim 1, further comprising:
transmitting, to a remote device, the at least one data;
analyzing, by the remoted device, the at least one data to determine at least one second insight;
determining, by the remote device, at least one second feedback based on the at least one second insight;
transmitting, to the wearable device, the at least one second feedback.

4. The system of claim 1, further comprising:
transmitting, to a remote device, the at least one data;
analyzing, by the remoted device, the at least one data to determine at least one second insight;
determining, by the remote device, at least one second feedback based on the at least one second insight;
displaying, on the remote device, the at least one second feedback.

5. A computer-implemented method for learning a task, comprising:
collecting, by a wearable device, at least one data associated with performance of the task;
analyzing, by the wearable device, the at least one data to determine at least one first insight;
providing, by the wearable device, at least one first feedback based on the at least one first insight.

6. The method of claim 4, wherein the analyzing is performed by one or more machine learning algorithms pre-loaded on the wearable device.

7. The method of claim 4, further comprising:
transmitting, to a remote device, the at least one data;
analyzing, by the remoted device, the at least one data to determine at least one second insight;
determining, by the remote device, at least one second feedback based on the at least one second insight;
transmitting, to the wearable device, the at least one second feedback.

8. The method of claim 4, further comprising:
transmitting, to a remote device, the at least one data;
analyzing, by the remoted device, the at least one data to determine at least one second insight;
determining, by the remote device, at least one feedback based on the at least one second insight;
displaying, on the remote device, the at least one second feedback.
